(19) United States
(12) Patent Application Publication
(10) Pub. No.: US 2011/0291034 A1
(43) Pub. Date: Dec. 1, 2011

(54) HYDRAULIC VALVE ASSEMBLY HAVING A CARTRIDGE INSERT VALVE EXHIBITING A CLOSING ELEMENT ARRANGED IN A PRESSURE EQUALIZED MANNER

(75) Inventors: Daniel Bunge, Willich (DE); Gero Scheffel, Korschenbroich (DE)

(73) Assignee: Parker-Hannifin GmbH, Bielefeld (DE)

(21) Appl. No.: 13/131,359

(22) PCT Filed: Nov. 19, 2009
(86) PCT No.: PCT/EP2009/008235

§ 371 Date: Aug. 10, 2011

(30) Foreign Application Priority Data
Nov. 26, 2008 (DE) 102008059058.4
Oct. 12, 2009 (DE) 102009049140.6

(51) Int. Cl. F16K 31/12

(52) U.S. Cl. 251/12

(57) ABSTRACT

The invention relates to a hydraulic valve assembly having a cartridge insert valve in a bore hole designed in a valve block and connected to the flow channels arranged in the valve block comprising a valve sleeve inserted in the bore hole and a closing member guided into said sleeve, wherein the valve sleeve forms a valve seat for the closing member in the closing position thereof and the closing member can be moved by means of a connected hydraulic pre-control between the closed position thereof seated on the valve seat and separating the flow channels from one another, and an opened position pushed into the valve sleeve, and the bore hole is sealed tight by the cartridge insert valve inserted the rein via a valve cover connected to the valve block. The closing member forms a sleeve-shaped closing element (17) exhibiting a through-hole (18) and thus ring surfaces on both ends thereof, the surfaces having identical area, and a pressure equalization chamber (19) corresponding with the through-hole (18) of the closing element (17) is formed in the valve cover (20) such that the closing element (17) is engaged on both sides with the pressure enacting in the adjustment direction of the element, which is seated completely pressure-equalized in the valve sleeve (14), wherein a radially protruding collar (21) having control surfaces (22, 23) opposite one another in the adjustment direction is arranged on the outer circumference of the closing element (17) for adjustment thereof. The control surfaces can be loaded by the control oil conducted via the hydraulic pre-control (25) for moving the closing element (17) in the valve sleeve (14), and the valve sleeve (14) inserted in the bore hole (11) of the valve block is fastened on the valve cover (20), the valve seat (16) formed on the valve sleeve (14) thereby maintaining an unaltered distance from the valve cover (20) during operation of the valve assembly.

The invention relates to a hydraulic valve assembly having a cartridge insert valve in a bore hole designed in a valve block and connected to flow channels arranged in the valve block, comprising a valve sleeve inserted in the bore hole and a closing member guided into said valve sleeve, wherein the valve sleeve forms a valve seat for the closing member in the closing position thereof and the closing member can be moved by means of a connected hydraulic pre-control between the closing position thereof seated on die valve seat and separating the flow channels from one another, and an opened position pushed into the valve sleeve, and the bore hole is sealed tight by the cartridge insert valve inserted therein by means of a valve cover connected to the valve block.

A valve assembly of this kind can be seen in the product catalog “Industriehydraulikventile” [Industrial Hydraulic Valves] of the company Parker Hannifin GmbH & Co. KG, Series TDA, catalog page 8-69. In the cartridge insert valve formed in this way and provided for inserting into a bore hole made in a valve block designed according to DIN ISO 7368, the hydraulic pre-control works on the entire upper surface of the closing member facing the valve cover. In particular, with increasing nominal size of the cartridge insert valve, the pressure to be brought by the hydraulic pre-control rises as well as the corresponding volume flow of control oil, in order to hold the closing member in its closing position against the pressure prevailing on the flow channels running through the valve sleeve in the adjustment direction of the closing member and thereby acting on the closing member. The significant control pressure also acts through the closing member on the valve sleeve and presses the valve sleeve into the bore hole of the valve block. In order to counteract this, DIN ISO 7368 provides that the bore hole to receive the (cartridge insert valve be offset by a step, so that the valve sleeve finds a position on the step of the bore hole, whereby the flow channel Formed in the valve block and joining the bore hole has a smaller diameter than the bore hole.

The known valve assembly is associated with the disadvantage that, due to the unavoidable tolerances in producing the bore hole within the valve block, different positions of the valve sleeve or of its valve seat in relation to the valve coyer can arise, since during operation of the cartridge insert valve, the valve sleeve can be pressed by the closing member under the effect of the control-oil pressure onto the step having a differing position each time, caused by the tolerance. This turns out to be disadvantageous especially, with Cartridge insert valves built as regulating valves, in which the open state, thus each position of the closing member toward the valve seat of the valve sleeve is critical.

From WO 2002/021032 A1, another valve assembly is known with a cartridge insert valve that can be inserted into a valve block whose closing member, which, can move in a valve sleeve, can be controlled between its opened position and its closed position by proportionally adjusted electromagnets. In order to reduce the position forces of the closing member, die pressure acting on the front side of the closing member is directed into a rear pressure space via an appropriate connection path, so that the closing member is essentially pressure-equalized. For this, according to an embodiment of WO 2002/021032 A1, the valve member designed as a hollow slider having assigned radial casing perforations to form a flow path between the flow channels formed in the valve block, also has an internal bore hole, starting from its interior space, and creating a connection to the rear pressure space, into which as a small tube is placed that goes through the interior space to the assigned flow channel of .the valve block, by means of which the pressure prevailing in the flow channel can be drained off to the rear pressure space.

The invention has as its object designing a valve assembly in accordance with the preamble having a position of the cartridge insert valve body that is independent of the manufacturing tolerances.

The solution of this object, including advantageous embodiments and further developments of the invention, results, from the content of the patent claims following this description.

The invention provides, in its basic idea, that the closing member is formed as a sleeve-shaped closing element exhibiting a through-hole and thus ring surfaces on both ends thereof, the surfaces having identical areas and a pressure-equalizing chamber corresponding with the through-hole of the closing element is formed within the valve cover such that the closing element is engaged on both sides with the pressure enacting in the adjustment direction of the element, which is seated completely pressure-equalized in the valve sleeve wherein a radially protruding collar having control services opposite one another in the adjustment direction is arranged on the outer circumference of the closing element for adjustment thereof, the control surfaces being loadable by the control oil conducted via the hydraulic pre-control for moving the closing element in the valve sleeve, and the valve sleeve inserted in the bore hole of the valve block is fastened on the valve cover, the valve seat formed on the valve sleeve thereby maintaining an unaltered distance from the valve cover during operation of the valve assembly.

The invention is associated with the advantage that because of the pressure-equalized arrangement of the closing element in the valve sleeve in regard to the pressure acting on the intake side, only very slight control forces are required to achieve the control of the closing element from the closing position to the opened position and back. For these reasons, small control surfaces are sufficient, as provided on me surrounding collar of the closing element. From this results the advantageous effect of reducing pressure to be created in the hydraulic pre-control, as well as the amount of control oil to be directed through the pre-control. Since, because of the low control pressure from the closing element a pressure load no longer goes in the direction of the valve sleeve, it is now possible to hold the valve sleeve on the valve cover so that the valve sleeve and thereby the valve seat formed on the valve sleeve always has the same unchanged position with respect to the valve cover. The opening point of the cartridge insert valve thus also stays fixed and is not subjected to any changes during mounting of the cartridge insert valve in the bore hole of the valve block and in operation of the cartridge insert valve.

Due to the lack of pressure exerted by the closing element on the valve sleeve, it is no longer required that the valve sleeve be supported in the valve block and to this extent that the bore hole to receive the cartridge insert valve be formed with steps. Since the valve sleeve according to the invention is held on the valve cover, it is sufficient that the flow channel formed in the valve block in the adjustment direction of the closing element of the cartridge insert valve has the same diameter throughout, like the bore hole serving to receive the cartridge insert valve. This is associated with the advantage that with the same drilling expenditure, the quantity of fluid directed through the valve block is increased.

Pursuant to a first embodiment of the invention, the valve sleeve is held on the valve cover by means of screws screwed through the valve cover into the walls of the sleeve.

Pursuant to an alternative embodiment, the valve sleeve having an outer (threading is screwed into an opening formed in the valve cover being provided with an inner threading and thereby is fixed to the valve cover in a defined position.

To the extent that the control oil directed through the hydraulic pre-control shall effect the movement of the closing element according to an embodiment of the invention the collar of the closing element having the control surfaces formed on it is arranged In a control-oil space whose regions on both sides of the collar are each connected to the hydraulic pre-control through a control-oil bore hole.

In regard to the arrangement of the control-oil space, pursuant to a first embodiment of the invention, it is provided that the collar of the closing element is arranged on a region of the closing element outside the valve sleeve and that the control-oil space and the control-oil bore holes are arranged within die valve cover. In this embodiment, the overall hydraulic control of the movement of the closing element is arranged within the valve cover. It can be provided here that the diameter of the collar of the closing element forming the control surfaces does not extend beyond the outer diameter of the valve sleeve.

In view of reducing the instruction according to an alternative embodiment it can be provided that the collar of the closing element is arranged on a region of the closing element lying inside the valve sleeve and that the control-oil space formed within the wall of the valve sleeve. In this embodiment, the features that contribute to the movement of the closing element are now transferred into the region of the valve sleeve, so that only the control-oil bore holes are placed in the valve cover.

According to an embodiment of the invention, the valve sleeve can still extend into the valve cover, which gives the possibility that the region of the valve sleeve that has the control-oil space lies within the valve cover and the control-oil bore holes run within the valve cover.

Alternatively, it is appropriate for the control-oil space to be arranged in the region of the valve sleeve locked within a bore bole of the valve block and that the control-oil bore holes run from the front surface of the valve sleeve adjacent to the valve cover through the wall of the valve sleeve to the control-oil space, whereby, in an appropriate manner, the control-oil bore holes running through the valve cover start from the upper side of the valve cover and run parallel to the screws that fasten the valve sleeve to the valve cover, and continue correspondingly within the wall of the valve sleeve.

As the valve sleeve no longer lies with its front side against a step of a bore hole and in this position it can no longer be sealed, it is provided according to an embodiment of the invention that the valve sleeve placed in the bore hole of the valve block is sealed on its outer circumference against the valve block by means of seal placed between them.

As also realized in the state of the art, it can be provided that the closing element is pre-stressed by a spring supported in the valve cover into its closed position abutting on the valve seat of the valve sleeve.

In the drawing, embodiments of the invention are shown, which are described in the following.

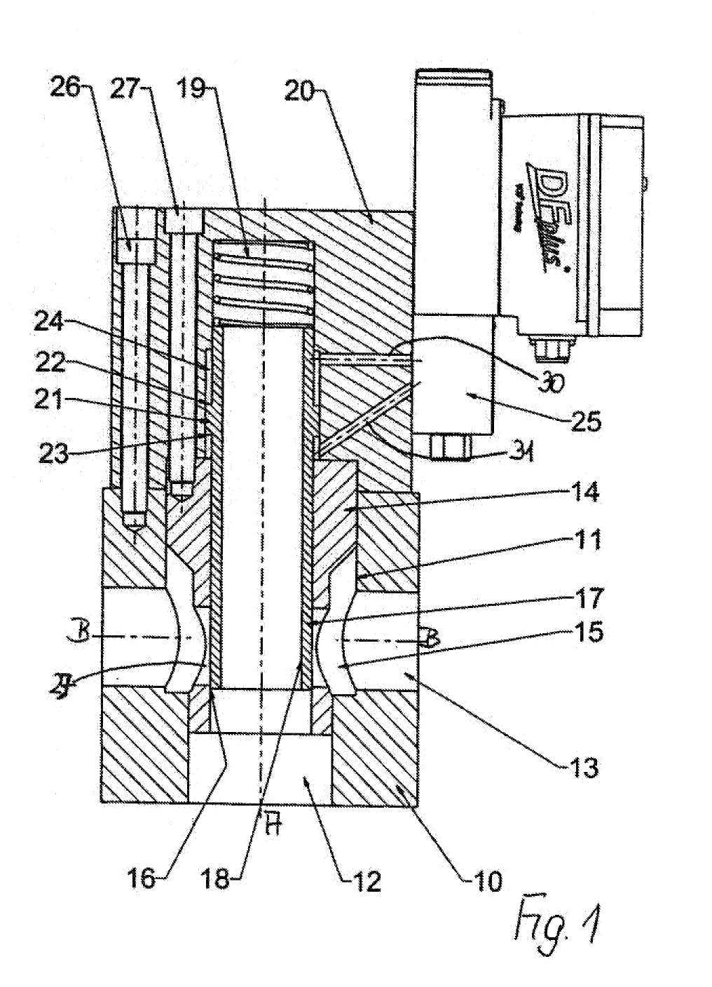

FIG. 1 shows a cartridge insert valve arranged in a valve block in a schematic view having a hydraulic pre-control arranged in the valve cover.

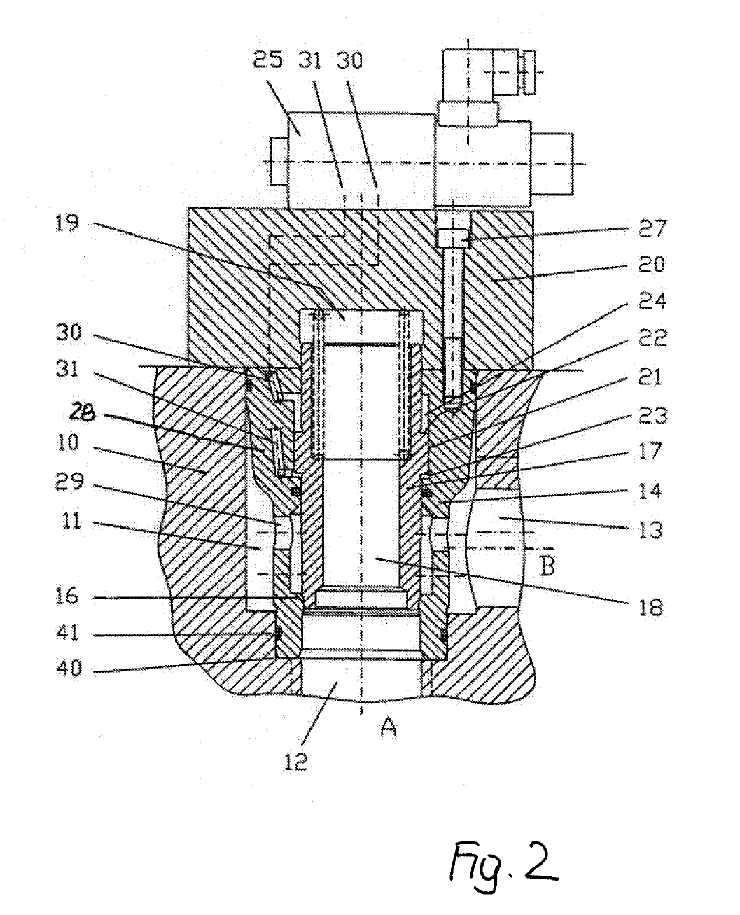

FIG. 2 shows the object of FIG. 1 in another embodiment with the control of the valve member transferred largely into the valve sleeve.

According to the embodiment shown in FIG. 1, a bore hole 11 is made in a valve block 10 to receive a cartridge insert valve to be described later. In the valve block 10, a flow channel 12 (connection A) and a flow channel 13 (connection B) are also arranged, each connected to the bore hole 11 in such a way that the connection between the flow channels 12 and 13 can be closed or opened by the cartridge insert valve placed in the bore hole 11. The bore hole 11 is closed by a valve cover 20 placed on the valve block 10 and fastened firmly to it by means of screws 26.

The cartridge insert valve placed in the bore hole 11 of the valve block 10 consists of a valve sleeve 14 placed in the bore hole 11, in which a closing element 17 can move. The valve sleeve 14 has in the region of the flow channel 13 (connection B) starting from the bore hole 11 several openings 29 for exit of the hydraulic fluid directed through flow channel 12 (connection A) into the valve block 10, and to receive the hydraulic fluid exiting from the valve sleeve 14, the bore hole 11 is expanded with a conical cavity 15 surrounding the valve sleeve 14, which makes it possible for the hydraulic oil exiting from the valve sleeve 14 to flow to flow channel 13. At its lowest point, the valve Sleeve 14 has a valve seat 16 for the closing element 17, which in his closing position seating on the valve sleeve seat 16 blocks the flow channel 12 (connection A) from flow channel 13 (connection B).

The closing element 17 has a passage through hole 18 that extends through it over its length, so that the closing element 17 is in turn designed in the manner of a sleeve with ring surfaces at each of its ends formed with identical areas. In the valve cover 20, a pressure-equalizing chamber 19 is formed corresponding with the through hole 18 of the closing element 17, so that also in its closed position, the closing element is impinged by the pressure acting from the from flow channel 12 (connection A) on both sides and is mounted completely pressure-equalized within the valve housing 14, A spring is arranged in the pressure-equalizing chamber 19, to pre-stress the closing element 17 into its closing position abutting on the valve seat 16 of the valve sleeve 14.

In order for it to be moved, the closing element 17 is provided in its region extending into the valve cover 20 with a radially projecting collar 21 with control surfaces 22 and 23 lying opposite each other in the adjustment direction, whereby the collar 21 with control surfaces 22,23 is arranged in a control-oil space 24 that in turn is connected via control-oil bore holes 30,31 to a hydraulic pre-control 25 which in the shown embodiment is placed on the valve cover 20 and is thereby connected to the control-space 24. In the embodiment as shown in FIG. 1, thereby the hydraulic pre-control provided for controlling the movement of the closing element 17 is arranged completely within the valve cover 20.

The valve sleeve 14 is held on the valve cover 20 by screws 27 that reach through the valve cover 20 into the wall of the valve sleeve 14.

It should also be recognized that in comparison to die state of the art, especially the arrangement of bore holes specified by DIN ISO 7368, the connection bore hole 12 has the same diameter or cross-section as the bore hole 11 made in the valve block 10 to receive the cartridge insert valve, without considering the conical cavity 15 that expands the bore hole 11. As to this extent, through connection A (flow channel 12) a significantly larger quantity of hydraulic fluid can thus be directed into the valve block a second connection B is shown schematically in order to make clear in comparison with the state of the art, that a correspondingly larger amount of hydraulic fluid can be directed via two connections B. Obviously, flow channel 13 (connection B) can also be designed with a corresponding size.

Because of the pressure-equalized position of the closing element 17 in the valve sleeve 14, the closing element 17 can be adjusted by the hydraulic pre-control 25 and the control surfaces 22 and 23 arranged on its collar 21 in each of the desired movement directions by control-oil directed into the control-oil space 24 into die desired direction, whereby only slight control forces are required. Since, due to these slight control forces, the closing element 17 in its closing position exerts no critical force on die valve sleeve 14 or on the valve seat 16, it is sufficient that the valve sleeve 14 is held on the valve cover 20 by correspondingly arranged screws 27. It is thereby assured that the salve seat 16 formed on the valve sleeve 14 always has the same unvarying distance from the valve cover 20, so that the opening point of the cartridge insert valve determined by the lifting of the closing element 17 from the valve seat 16 undergoes no changes.

The embodiment shown in FIG. 2 differs from the preceding embodiment described with respect to FIG. 1 essentially in that me control-oil space 24 with the collar 21 of the closing element 17 guided herein has been transferred into the valve sleeve 14, be as far as the control-oil space 24 is how formed in the wall 28 of the valve sleeve 14, specifically in a region of the valve sleeve 14 that is located completely inside the bore hole 11 of the Valve block 10. In the shown embodiment the valve sleeve 14 of the cartridge insert valve is thus extensively received in the valve block 10 and projects with its front surface only slightly from the surface of the valve block 10 and Correspondingly into the pressure-equalizing chamber 19 formed in die valve cover 20. As not shown further, the valve sleeve 14 of the inserted cartridge insert valve can be received completely within the valve block 10 and can end with its front surface against the valve cover 20.

This means that also the two control-oil bore holes 30,31 leading to the control-oil space 24 in their region lying in the valve block extend within the wall 28 of the valve sleeve 14 until the front surface of the valve sleeve adjacent to the valve cover 20 and then continue until the pre-control 25 arranged on the valve cover 20 through the valve cover 20 situated on the valve block 10 and being screwed to it. To this extent, in the embodiment seen in FIG. 2, the control that effects the movement of the closing element 17 is transferred into valve sleeve 14, so that only the pressure-equalizing chamber 19 and the control-oil bore holes 30,31 leading to the hydraulic pre-control 25 need to be formed within the valve cover 20.

In the embodiment shown in FIG. 2, and in a modification of the embodiment described in FIG. 1 the bore hole 11 is formed with a step in such a way that the valve sleeve 14 stands on the step 40 formed in this way and is sealed on its outer circumference by means of a seal 41 against the valve block 10. In addition, only one flow channel 13 (connection B) is present. The function of the cartridge insert valve shown in FIG. 2 is in accordance with the embodiment described with respect to FIG. 1.

The characteristics of the object disclosed in the above description, the patent claims, the summary, and the drawings of this document can be essential individually as well as in any combination with one another for implementing the invention in its most various embodiments.

1. A hydraulic valve assembly having a cartridge insert valve in bore hole designed in a valve block and connected to flow channels arranged in the valve block, comprising a valve sleeve inserted in the bore hole and a closing member guided into said valve sleeve, wherein the valve sleeve forms a valve seat for the closing member in the closing position thereof and the closing member can be moved by means of a connected hydraulic pre-control between the closing position thereof seated on the valve seat and separating the flow channels from one another, and an opened position pushed into the valve sleeve, and the bore hole is sealed tight by the cartridge insert valve inserted therein by means of a valve cover connected to the valve block, characterized in that the closing member is formed as a sleeve-shaped closing element (17) exhibiting a through-hole (18) and thus ring surfaces on both ends thereof, the surfaces having identical areas and pressure-equalizing chamber (19) corresponding with the through-hole (18) of the closing element (17) is formed within the valve cover (20) such that the closing element (17) is engaged on both sides with the pressure enacting in the adjustment direction of the element, which is seated completely pressure-equalized in the valve sleeve (14) wherein a radially protruding collar (21) having control services (22,23) opposite one another in me adjustment direction is arranged on the outer circumference of the closing element (17) for adjustment thereof, the control surfaces being loadable by the control oil conducted via the hydraulic pre-control (25) for moving the closing element (17) in the valve sleeve (14), and the valve sleeve (14) inserted in the bore hole (11) of the valve block is fastened on the valve cover (20), the valve seat (16) formed on the valve sleeve (14) thereby maintaining an unaltered distance from the valve cover (20) during operation of the valve assembly.

2. A hydraulic valve assembly according to claim 1, characterized in that the flow channel (12) formed in the valve block (10) in the adjustment direction of the closing element (17) of the cartridge insert valve has an inner diameter corresponding to the outer diameter of the inserted valve sleeve (14).

3. A hydraulic valve assembly according to claim 1 or 2, characterized in that the valve sleeve (14) is held on the valve cover (20) by means of screws (27) that go through the valve cover (20) into the sleeve wall.

4. A hydraulic valve assembly according to claim 1 or 2, characterized in that the valve sleeve (14) having an outer threading is screwed into an opening formed in the valve cover (20) being provided with an inner threading and thereby is fixed to the valve cover (20) in a defined position.

5. A hydraulic valve assembly according to one of claims 1 through 4, characterized in that the collar (21) of the closing element (17) having the control surfaces (22,23) formed on it is arranged in a control-oil space (24), whose regions on both sides of the collar (21) are each connected to the hydraulic pre-control (25) through a control-oil bore hole (30,31).

6. A hydraulic valve assembly according to claim 5, characterized in that the collar (21) of the closing element (17) is arranged on a region of the closing element (17) outside the valve sleeve (14) and that the control-oil space (24) and the control-oil bore holes (30,31) are arranged within the valve cover (20).

7. A hydraulic valve assembly according to claim 5 or 6, characterized in that the collar (21) forming the control surfaces (22,23) of the closing element (17) does not extend with its outer diameter beyond the outer diameter of the valve sleeve (14).

8. A hydraulic valve assembly according to claim 5, characterized in that the collar (21) of the closing element (17) is arranged on a region of the closing element lying inside the valve sleeve (14) and the control-oil space (24) is formed within the wall (28) of the valve sleeve (14).

9. A hydraulic valve assembly, according to claim 8, characterized in that the region of the valve sleeve (20) having the control-oil space (24) lies within the valve cover (20) and the control-oil bore holes (30,31) run within the valve cover (20).

10. A hydraulic valve assembly according to claim 3 and 8, characterized in that the control-oil space (24) is arranged in the region of the valve sleeve (14) located within a bore hole (11) of the valve block (10) and that the control-oil bore holes (30,31) run from the front surface, bf the valve sleeve (14) adjacent to the valve cover (20) through the wall (28) of the valve sleeve (14) to the control-oil space (24).

11. A hydraulic valve assembly according to claim 10, characterized in that the control-oil bore holes (30,31) running through the valve cover (20) start from the upper side of the valve cover (20) and run parallel to the screws (27) fastening the valve sleeve (14) to the valve cover (20) and continue correspondingly within the wall (28) of the valve sleeve (14).

12. A hydraulic valve assembly according one of claims 1 through 11, characterized in that the valve sleeve (14) inserted in the bore hole (11) of the valve block (10) is sealed on its outer circumference against the valve block (10) by means of a seal (41) placed between them.

13. A hydraulic valve assembly according to one of claims 1 through 12, characterized in that the closing element (17) is pre-stressed in its closed position by a spring supported in the valve cover (20) in its closed position abutting on the valve seat (16) of the valve sleeve (14).
